(19) United States
(12) Patent Application Publication
(10) Pub. No.: US 2016/0307684 A1
(43) Pub. Date: Oct. 20, 2016

(54) WINDING COMPONENT

(71) Applicant: FDK CORPORATION, Tokyo (JP)

(72) Inventors: Takashi TAKIGUCHI, Tokyo (JP); Mikio KITAOKA, Tokyo (JP); Satoshi OTA, Tokyo (JP)

(21) Appl. No.: 15/102,643

(22) PCT Filed: Jan. 21, 2015
(86) PCT No.: PCT/JP2015/000246

§ 371 Date: Jun. 8, 2016

(30) Foreign Application Priority Data
Jan. 27, 2014 (JP) 2014-012179

(51) Int. Cl. H01F 27/08; H01F 27/28

(52) U.S. Cl. CPC H01F 27/08; H01F 27/2823

(57) ABSTRACT

There is provided a winding component capable of reducing the core temperature compared to the past even in a usage scenario where the amount of core heat generation is great, and whose size and weight may be reduced as a result. The present invention is a winding component including a coil (2) and a pair of upper and lower cores (4, 5) that form a closed magnetic path by surrounding an outer perimeter of the coil (2), the winding component having a bottom surface of the lower core (5) mounted on a housing (1) with a heat dissipation function, where a metal plate (7) having a higher thermal conductivity than the lower core (5) is attached to an outer side surface (6) of the lower core (5).

### TECHNICAL FIELD

The present invention relates to a winding component to be used in electronic and electrical appliances, and more particularly, to a winding component to be used in a high current power supply.

### BACKGROUND ART

With a winding component such as an inductor or a transformer having a coil and a core forming a magnetic circuit, when the product temperature is increased due to heat generation at the time of use and the heatproof temperature of a structural member is exceeded, damage or degradation may be caused.

In recent years, there is a strong demand to reduce the size and weight of such a winding component. However, if the wire diameter of the coil is reduced or the core is made small to achieve reduction in size and weight of the winding component, there is a harmful effect that the amount of heat generation is increased, and the product temperature is even more increased.

Accordingly, for example, a winding component meeting high current specifications, which generates a large amount of heat, often adopts a structure for releasing heat generated by the winding component to outside by having the bottom surface of the core in contact with a casing having a heat dissipation function, as disclosed in Patent Literatures 1 and 2.

According to an attachment structure of a winding component whose core is in contact with the heat dissipation housing so as to dissipate heat, the temperature of the bottom surface side of the core in contact with the housing is low, but the temperature of the core at a position away from the bottom surface (especially, at near the upper surface) cannot be reduced as much as at the bottom surface. Also, in the case where an alternating magnetic field flows through the core, there is occurrence of iron loss (heat generation in the core). Furthermore, the temperature at the upper surface of the core due to self-heating is proportional to about the square of a thermal path length, and thus there is a problem that, if the height of the core is doubled, the core temperature difference is increased by about four times.

Accordingly, as an example of a solution to the problem, there is proposed a structure as shown in FIG. 5 in which an inductor 50 (coil is not shown) forming a closed magnetic path by a pair of E-shaped cores 51, 52 is mounted on a heat sink 53 for heat dissipation with a bottom surface 52a of the lower core 52 attached to the heat sink 53, and in which a metal plate 54 is provided extending along an upper surface 51a and a side surface 51b of an outer leg of the upper core 51 and a side surface 52b of an outer leg of the lower core 52 to the heat sink 53.

According to the attachment structure of the conventional inductor 50 described above, since the thermal conductivity of ferrite material generally used as the cores 51, 52 is about 5 W/m·k, and the thermal conductivity of the metal plate 54 is higher than that of the ferrite material, there is an advantage that, by causing a part of heat generated at the upper core 51 to flow to the metal plate 54, the temperature of the cores 51, 52 may be reduced.

However, the upper and lower cores 51, 52 are manufactured by sintering a powder of the ferrite material, and the dimensional tolerance is larger than that of general machine parts, and for example, the dimensional tolerance may be ±1 mm or more for a large high-power core. In this case, as shown in FIG. 5, a dimensional difference is caused between the upper and lower cores 51, 52 of the inductor 50 combining the upper and lower cores 51, 52, and a large gap L is caused between the metal plate 54 and the side surface 52b of the outer leg of the lower core 52.

As a result, there is a problem that, although heat is smoothly conducted between the upper core 51 and the metal plate 54 because the upper core 51 and the metal plate 54 are in contact with each other, heat is not easily transferred from the lower core 52 to the metal plate 54 and thermal resistance is great between the core 52 and the metal plate 54, and the effect of reduction in the core temperature cannot be sufficiently obtained.

### CITATION LIST

### Patent Literature

Patent Literature 1: Japanese Patent Laid-Open No. 2009-206308

Patent Literature 2: Japanese Patent Laid-Open No. 2011-61096

### SUMMARY OF INVENTION

### Technical Problem

Accordingly, the present inventors have studied the temperature distribution in a core 40, as shown in FIG. 6A, of a winding component (also in this case, coil is not shown) 42 attached to a heat dissipation structure 41 with a bottom surface 40a of the core 40 mounted on the heat dissipation structure 41, and have found that the temperature distribution in the core 40 due to iron loss (heat generation in the core itself due to an alternating magnetic flux) is parabolic, as shown in FIG. 6B. Accordingly, a temperature change over a unit distance (for example, 1 mm) over the thermal path is great near X=0 (that is, on the bottom surface side of the core 40), and small near X=L (that is, on the upper portion side of the core 40).

The reason is assumed to be that the heat of the core 40 flows from the upper portion to the bottom portion 40a side that is in contact with the heat dissipation structure 41, but because the core 40 is a self-heating body, the accumulated thermal dose from the upper portion becomes greater as it gets near the bottom portion of the core 40, thereby causing the temperature difference per unit distance to be increased.

Accordingly, it was found that, with the winding component shown in FIG. 6A, if the cross-sectional area of the thermal path at the lower portion of the core 40 where the accumulated thermal dose is great can be increased and the thermal resistance at the lower portion of the core 40 may be reduced, the temperature of the entire core 40 may be reduced.

The present invention has been made based on the finding described above, and has its aim to provide a winding component capable of reducing the core temperature compared to the past even in a usage scenario where the amount of core heat generation is great, and whose size and weight may be reduced as a result.

### Solution to Problem

To solve the above problem, an invention according to a first mode (described in claim 1) of the present invention is a winding component including a coil and a pair of upper and lower cores that form a closed magnetic path by surrounding an outer perimeter of the coil, the winding component having a bottom surface of the lower core mounted on a housing with a heat dissipation function, where a metal plate having a higher thermal conductivity than the lower core is attached to an outer side surface of the lower core.

Also, an invention according to a second mode (described in claim 2) of the present invention is the invention according to the first mode, where the upper and lower cores are E-shaped cores, and the metal plate is attached to an outer side surface of an outer leg of the lower core.

Also, an invention according to a third mode (described in claim 3) of the present invention is the invention according to the first or the second mode, where the metal plate is bonded to the outer side surface of the lower core by a silicon-based adhesive.

Furthermore, an invention according to a fourth mode (described in claim 4) of the present invention is the invention according to any one of the first to the third modes, where the upper and lower cores are ferrite cores, and the metal plate is a copper plate or an aluminum plate.

### Advantageous Effects of Invention

According to the invention of any one of the first to the fourth modes (described in claims 1 to 4) of the present invention, since a metal plate having a higher thermal conductivity than the lower core of the winding component including a pair of the upper and lower cores is provided on the outer side surface of the lower core mounted on a housing with a heat dissipation function, even if a step or level difference is formed, at the time of manufacturing, between the outer side surfaces of the upper and lower cores due to the dimensional tolerance, the entire surface of the metal plate may be placed in close contact with the outer side surface of the lower core.

Accordingly, by increasing the cross-sectional area of the thermal path at the lower core where the accumulated thermal dose from the upper core is great, the thermal resistance of the lower core is reduced, and the temperature of the entire cores may be reduced.

As a result, even in a usage scenario where the amount of core heat generation is great, the core temperature may be reduced compared to the past. In other words, even if the amount of heat generation is great, a rise in the temperature of the winding component may be suppressed, and the size and weight may be reduced.

Additionally, when the metal plate is provided on the outer side surface of the lower core, a small gap is locally caused between the outer side surface and the metal plate. Accordingly, the thermal resistance between the two is increased due to presence of air having a low thermal conductivity in the gap, and the effect of reducing the core temperature is possibly impaired.

However, according to the invention of the third mode (described in claim 3), since a metal plate is bonded to the outer side surface of the lower core by a silicon-based adhesive having a good thermal conductivity, the gap is filled with a medium (adhesive) having a higher thermal conductivity than air, and the thermal resistance between the two may be reduced.

Moreover, even if the core and the metal plate are relatively displaced at the time of use of the winding component due to different thermal expansion rates, the silicon-based adhesive is heat resistant and elastic, and an excessive stress due to the relative displacement may be prevented from being applied to the core having poor elasticity.

### BRIEF DESCRIPTION OF DRAWINGS

FIG. 1 is an overall perspective view showing an embodiment of the present invention.

FIG. 2 is a vertical cross-sectional view of FIG. 1.

FIG. 3 is a vertical cross-sectional view showing another example of the present invention.

FIG. 4 is a perspective view showing an attachment mode of a winding component used in an example of the present invention.

FIG. 5 is a vertical cross-sectional view of a conventional winding component.

FIG. 6A is a vertical cross-sectional view schematically showing the flow of heat in cores of a winding component installed on a heat dissipation structure.

FIG. 6B is a graph showing a temperature distribution in the cores.

### DESCRIPTION OF EMBODIMENTS

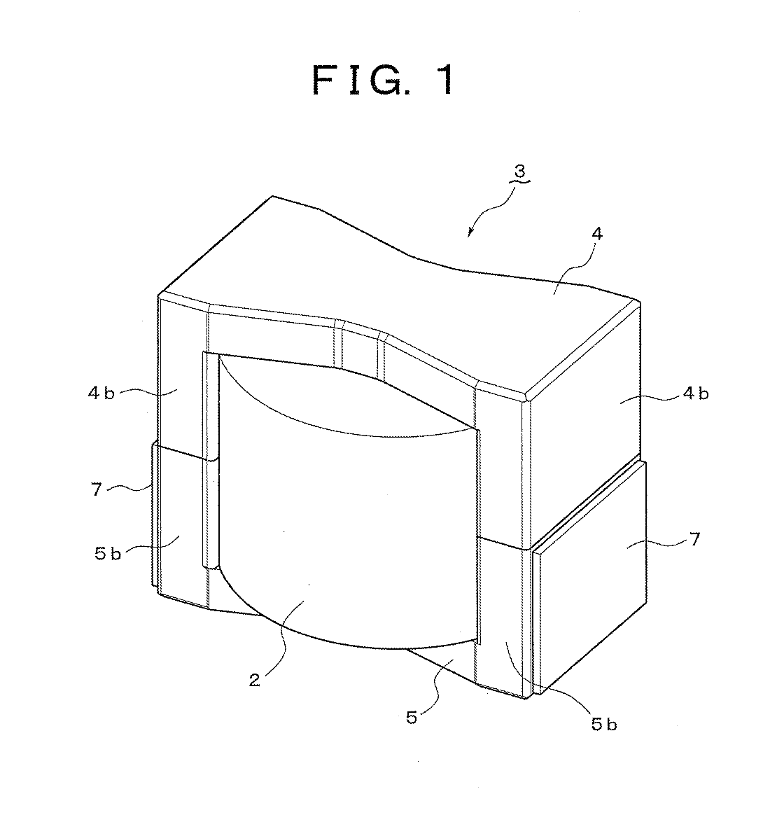

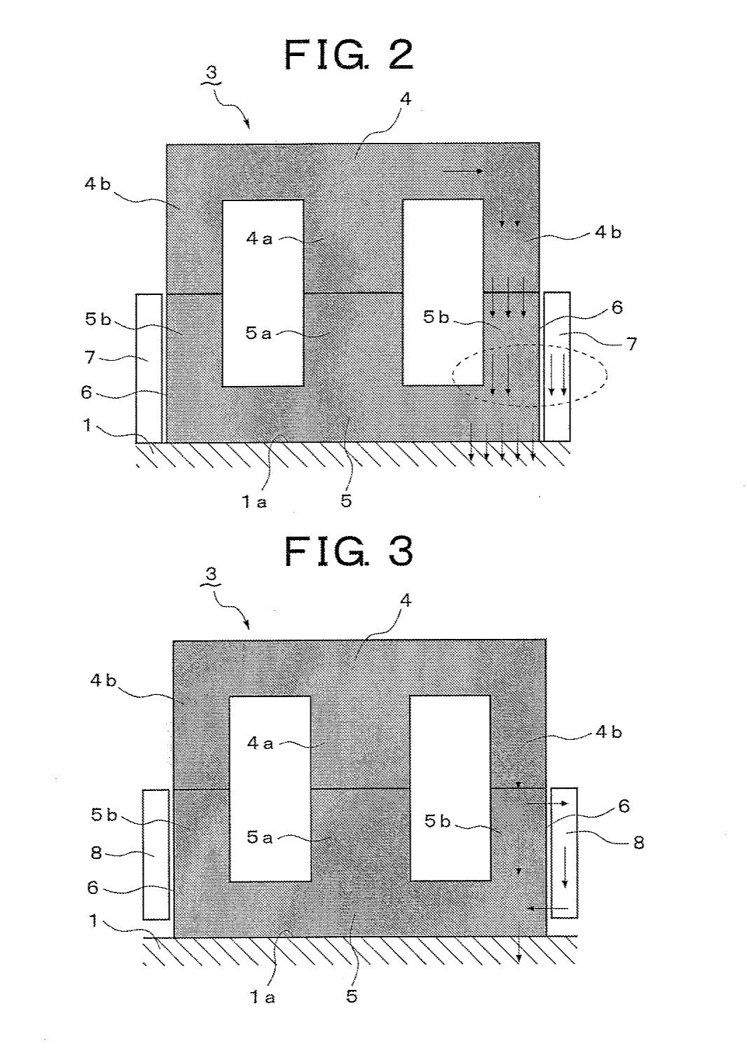

FIGS. 1 and 2 show an embodiment of application of a winding component according to the present invention to an inductor, and a reference sign 1 in the drawing is a housing on which the inductor is to be mounted.

The housing 1 is a die-cast member provided with a heat dissipation function by a cooling water channel for water cooling or an air-cooling fin, not shown, and its upper surface is a mounting surface 1a for an inductor 3.

For its part, the inductor 3 of the present embodiment has a pair of upper and lower cores 4, 5 disposed on the outer perimeter of a bobbin 2 on which a coil is wound, and a bottom surface of the lower core 5 is placed on the mounting surface 1a of the housing 1. The pair of upper and lower cores 4, 5 are E-shaped cores formed of ferrite material, and are disposed to form a closed magnetic path by surrounding the outer perimeter of the coil 2, by having middle legs 4a, 5a inserted in a center hole of the bobbin 2 and outer legs 4b, 5b disposed on the outer perimeter of the bobbin 2 along the axial direction with respective tip end surfaces abutting each other.

With the inductor 3, a metal plate 7 made of copper or aluminum (including an aluminum alloy) having a higher thermal conductivity than the lower core 5 is attached to an outer side surface 6 of the outer leg 5b of the lower core 5. The metal plate 7 is formed having substantially the same dimension as the outer side surface 6 of the outer leg 5b of the lower core 5, and is bonded to the outer side surface 6 by a silicon-based adhesive. In this case, after the adhesive is applied, a specific pressure is desirably applied to the two to reduce the thickness of the adhesive layer as much as possible and to make the thickness constant.

According to the inductor 3 having the above structure, since the metal plate 7 having a higher thermal conductivity than the core is provided on the outer side surface 6 of the outer leg 5b of the lower core 5 mounted on the housing 1 having a heat dissipation function, even if a step or level difference is formed, at the time of manufacturing, between the outer side surfaces of the outer legs 4b, 5b of the upper and lower cores 4, 5 due to dimensional tolerance, the entire surface of the metal plate 7 may be placed in close contact with the outer side surface 6 of the outer leg 5b of the lower core 5.

The cross-sectional area of the thermal path may thus be increased by the metal plate 7 at the part of the outer leg 5b (the range shown by a dotted ellipse in FIG. 2) of the lower core 5 where the accumulated thermal dose from the upper core 4 is great, and the temperature of the lower core 5 is reduced, and the temperature of the entire upper and lower cores 4, 5 may be reduced.

As a result, even in a usage scenario where the amount of core heat generation is great, the temperature of the upper and lower cores 4, 5 may be reduced compared to the past. Accordingly, because a rise in the temperature of the entire inductor 3 may be suppressed even when the amount of heat generation is great, the size and weight of the inductor 3 may be reduced.

Moreover, because the metal plate 7 is bonded to the outer side surface 6 of the outer leg 5b of the lower core 5 by a silicon-based adhesive, the effect of reducing the core temperature may be prevented from being impaired due to the thermal resistance between the two being increased by presence of air having a low thermal conductivity in the gap between the two.

Moreover, even if the lower core 5 and the metal plate 7 are relatively displaced at the time of use of the inductor 3 due to different thermal expansion rates, the silicon-based adhesive is heat resistant and elastic, and an excessive stress due to the relative displacement may be prevented from being applied to the lower core 5 having poor elasticity.

Additionally, in the embodiment described above, only a case where the metal plate 7 is provided being bonded to the entire surface of the outer side surface 6 of the outer leg 5b of the lower core 5 is described, but the present invention is not limited thereto. For example, as in another example shown in FIG. 3, a metal plate 8 with less height than the metal plate 7 may be provided being bonded to the outer side surface 6 of the outer leg 5b of the lower core 5, with a gap to the mounting surface 1a of the housing 1, and substantially the same effect may be obtained by this structure.

In FIG. 2, the contact area between the metal plate 7 and the mounting surface 1a is small, and the thermal resistance between the metal plate 7 and the mounting surface 1a is great, and thus, in effect, the amount of heat that flows directly from the metal plate 7 to the mounting surface 1a is small. In reality, a part of heat flowing from the outer leg 4b to the outer leg 5b flows to the metal plate 7 at an upper portion of the outer leg 5b, and after flowing through the metal plate 7, the heat returns to the outer leg 5b from the metal plate 7 at a lower portion of the outer leg 5b. That is, a part of heat which is to flow through the outer leg 5b makes a detour through the metal plate 7. In terms of thermal circuit, the thermal resistance is reduced by connecting the metal plate 7 having a higher thermal conductivity than the outer leg 5b in parallel. Therefore, substantially the same effect may be obtained even if the metal plate 7 and the mounting surface 1a are not in direct contact with each other in the manner shown in FIG. 2.

Additionally, the present invention may be widely applied to cases where various other winding components, such as a transformer, are to be attached to a housing with a heat dissipation function, without being limited to the inductor 5.

### Example

To study the effect of the present invention, the following experiment was conducted.

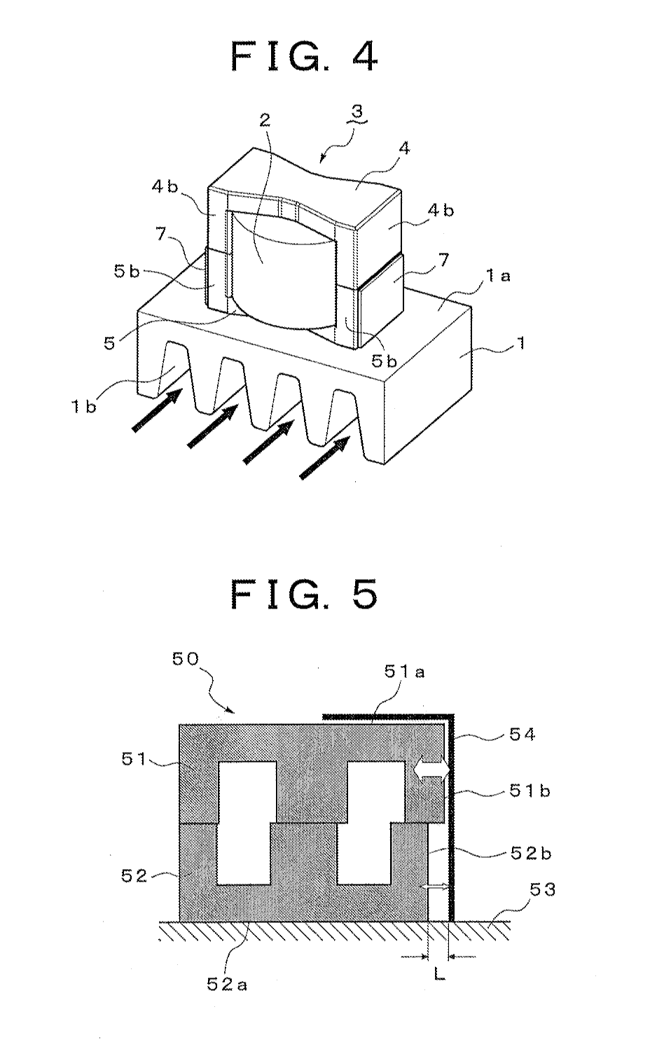

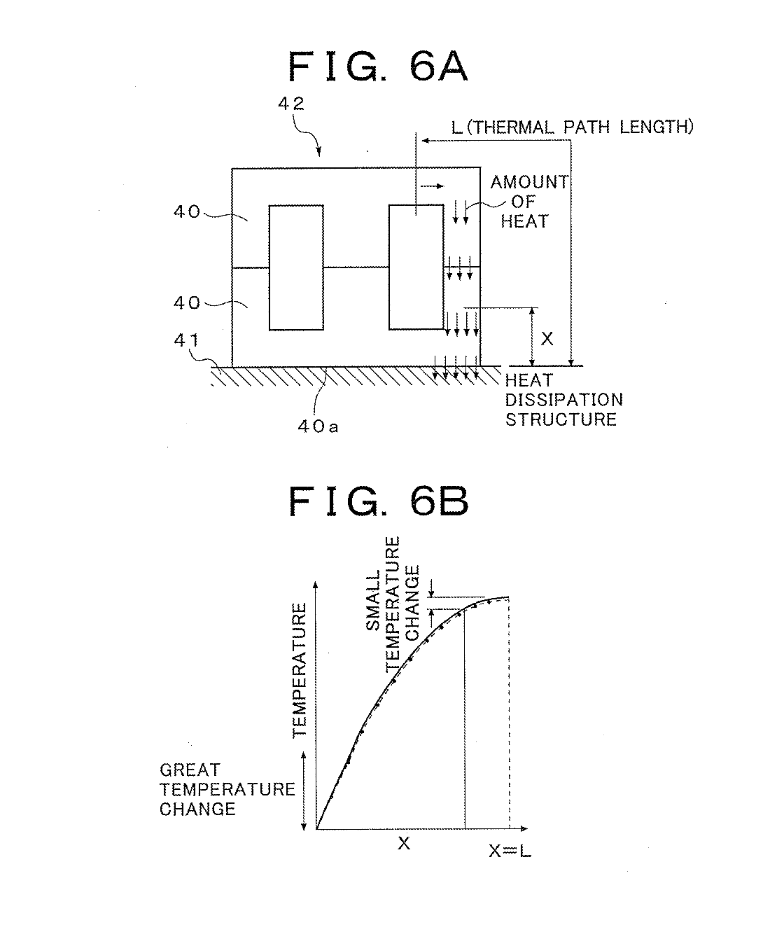

First, the temperature difference between the upper and lower cores 4, 5 was measured for a case, as shown in FIG. 4, where an example of the present invention which is the inductor 3 having the same structure as that shown in FIGS. 1 and 2 and which uses an aluminum plate as the metal plate 7 is mounted on a mounting surface 1a of a heat dissipation structure (housing) 1 having air-cooling fins 1b formed at the lower portion, and for a case of a conventional example where the metal plate 7 is not attached.

Additionally, in the example described above, the metal plate 7 is bonded to the outer side surface of the lower core 5 without its lower end portion being in direct contact with the mounting surface 1a of the housing 1. Also, the cores each have a height of 60 mm.

In the experiment described above, a temperature difference ΔT between the lower portion of the lower core 5 and a highest temperature portion at the upper portion of the upper core 4, at the time when the amount of core heat generation is 10 W, was measured. The result was ΔT=35.3° C. for the example described above, and ΔT=47.3° C. for the comparative example described above where the metal plate 7 was not provided. Accordingly, it was proven that, according to the example described above, the core temperature may be reduced by about 25% than the comparative example.

### INDUSTRIAL APPLICABILITY

A winding component capable of reducing the core temperature compared to the past even in a usage scenario where the amount of core heat generation is great, and whose size and weight may be reduced as a result may be provided.

### REFERENCE SIGNS LIST

1 Housing
1a Mounting surface
2 Bobbin on which a coil is wound
3 Inductor (winding component)
4 Upper core
5 Lower core
5b Outer leg
6 Outer side surface
7, 8 Metal plate

1. A winding component including a coil and a pair of upper and lower cores that form a closed magnetic path by surrounding an outer perimeter of the coil, the winding component having a bottom surface of the lower core mounted on a housing with a heat dissipation function,
wherein a metal plate having a higher thermal conductivity than the lower core is attached to an outer side surface of the lower core.

2. The winding component according to claim 1, wherein the upper and lower cores are E-shaped cores, and the metal plate is attached to an outer side surface of an outer leg of the lower core.

3. The winding component according to claim 1, wherein the metal plate is bonded to the outer side surface of the lower core by a silicon-based adhesive.

4. The winding component according to claim 1, wherein the upper and lower cores are ferrite cores, and the metal plate is a copper plate or an aluminum plate.
